(19) United States
(12) Patent Application Publication
(10) Pub. No.: US 2025/0377342 A1
(43) Pub. Date: Dec. 11, 2025

(54) FURTHER PURIFICATION TREATMENT METHOD FOR SAMPLE AFTER MAGNETIC BEAD EXTRACTION AND TREATMENT SYSTEM THEREFOR

(71) Applicant: Calibra Scientific, Inc., Hangzhou (CN)

(72) Inventors: Weijia WU, Hangzhou (CN); Pengyun LIU, Hangzhou (CN); Jianbing DU, Hangzhou (CN); Huafen LIU, Hangzhou (CN)

(21) Appl. No.: 19/228,556

(22) Filed: Jun. 4, 2025

Related U.S. Application Data
(60) Provisional application No. 63/658,104, filed on Jun. 10, 2024.
(60) Provisional application No. 63/658,090, filed on Jun. 10, 2024.

(51) Int. Cl. G01N 30/08; G01N 30/02; G01N 30/72

(52) U.S. Cl. CPC G01N 30/08; G01N 30/7233; G01N 2030/027

(57) ABSTRACT

A further purification treatment method for a sample after magnetic bead extraction and a treatment system therefor utilizes a magnetic rod plate that can be used in match with a well plate loaded with the sample. After the well plate is combined with a magnetic rod on the rod plate, the rod is located in a gap between reagent tubes in the well plate, and the rod is close to tube walls of the reagent tubes, such that residual magnetic beads and magnetic fragments in the sample in several reagent tubes around the rod can be simultaneously adsorbed and gathered. At this point, the sample is pipetted from the reagent tubes, and can be directly used for liquid chromatography-tandem mass spectrometry detection, and the accuracy of detection results can be ensured to the maximum extent. The method greatly facilitates subsequent treatment of the sample after magnetic bead extraction.

### CROSS-REFERENCE TO RELATED APPLICATIONS

The present application claims priority to U.S. Provisional Patent Application No. 63/658,104, filed on Jun. 10, 2024 and U.S. Provisional Patent Application No. 63/658,090, filed on Jun. 10, 2024, the entire content of each of which is incorporated as part of the present application.

### BACKGROUND OF THE INVENTION

### Field of the Invention

The present application belongs to the technical field of biology, and particularly relates to a further purification treatment method for a sample after magnetic bead extraction and a treatment system therefor.

### Description of the Related Art

Magnetic bead extraction is a method for separating and enriching target molecules from samples, widely used in fields such as biological sciences, medical research, and industrial production. It utilizes the specific binding between magnetic particles and target molecules to achieve separation and concentration of the target molecules through magnetic field assistance.

The principle of magnetic bead extraction is primarily based on the specific binding between immunomagnetic beads and target molecules. The surface of the magnetic beads is modified with antibodies or other chemical modification groups, which can specifically bind to target molecules (e.g., proteins and nucleic acids). The magnetic beads binding to the target molecules are gathered together under the action of a magnetic field, and are then eluted to separate the target molecules from the magnetic beads. Magnetic rods are used to adsorb and remove the magnetic beads, thereby achieving isolation and concentration of the target molecules. The remaining sample after magnetic bead extraction (the sample containing the target molecules) is expected to be directly used for liquid chromatography-tandem mass spectrometry detection.

However, in practical operations, it has been found that if the sample after magnetic bead extraction is directly used for liquid chromatography-tandem mass spectrometry detection, generally, a pipeline of a detection device may be blocked by residual magnetic beads and malfunctioned, or the magnetic beads or fragments thereof may be gathered at a six-way switch valve, causing wear to a rotor of the six-way valve, which results in an influence on the sample suction precision or even a loss of the sample suction function. The reason why the magnetic beads or fragments enter a liquid phase detection system may be that all residual magnetic beads or magnetic bead fragments in the sample cannot be sufficiently removed by using magnetic rod adsorption, and the residual magnetic beads or magnetic fragments thereof are still present in the sample, resulting in that a sample injection solution is not suitable for direct use in mass spectrometry detection and requires next purification treatment.

Existing common further purification treatment methods for a sample solution after magnetic bead extraction include filtration, centrifugation, and the like, which are cumbersome in operation procedures. Moreover, the sample requires multiple times of transfers and the replacement of reagent tubes, inevitably causing a sample loss, which affects the accuracy of detection results. Therefore, there is an urgent need to find a more efficient, simpler, and more convenient purification treatment method for a sample after magnetic bead extraction such that the sample can be directly used for liquid chromatography-tandem mass spectrometry detection.

### BRIEF SUMMARY OF THE INVENTION

To solve the above problems, the present application provides a further purification treatment method for a sample after magnetic bead extraction and a treatment system therefor. A magnetic rod plate that can be used in match with a well plate loaded with the sample is designed. After the well plate is combined with a magnetic rod on the magnetic rod plate, the magnetic rod is located in a gap between reagent tubes in the well plate, and the magnetic rod is close to tube walls of the reagent tubes, such that residual magnetic beads in the sample in several reagent tubes around the magnetic rod can be simultaneously adsorbed and gathered and no longer move. At this point, the sample without immobilized magnetic beads and magnetic fragments is pipetted from the reagent tubes, and can be directly used for liquid chromatography-tandem mass spectrometry detection, and the accuracy of detection results can be ensured to the maximum extent. The method is simple and efficient in operation, and the magnetic rod plate for matched use is simple in structure and low in cost, and can be reused infinitely, thereby greatly facilitating the requirements for further purification treatment of the sample after magnetic bead extraction, and showing broad market prospects.

In an aspect, the present application provides a further purification treatment method for a sample, wherein the sample is a sample solution subjected to magnetic bead extraction, and the treatment method includes treating the sample with a magnetic material such that residual magnetic beads or magnetic fragments in the sample are adsorbed and immobilized by the magnetic material, and then pipetting the sample without immobilized magnetic beads and magnetic fragments, which is directly used for liquid chromatography-tandem mass spectrometry detection.

A method for the magnetic bead extraction of the present application includes the following steps: (1) activating magnetic beads; (2) adding the magnetic beads to a sample, and the magnetic beads binding to target molecules in the sample; (3) washing the magnetic beads; (4) eluting the magnetic beads to separate the target molecules from the magnetic beads; and (5) using a magnetic rod to adsorb and remove the magnetic beads, such that the remaining sample is the sample solution after magnetic bead extraction.

Most magnetic beads in the sample after magnetic bead extraction are adsorbed and removed by the magnetic rod. However, some residual magnetic beads or magnetic fragments in the sample solution are still unavoidable. When the sample is directly used for liquid chromatography-tandem mass spectrometry detection, a pipeline of a detection device is very easily blocked by the residual magnetic beads in the sample, or the magnetic beads or fragments thereof may be gathered at a six-way switch valve, causing wear to a rotor of the six-way valve, which results in an influence on the sample suction precision or even a loss of the sample suction function. In the present application, it has been proven by research that when the sample was treated again with a magnetic material (e.g., a magnetic rod), residual magnetic beads or magnetic fragments in the sample are adsorbed and immobilized by the magnetic material, at this point, the sample without immobilized magnetic beads or magnetic fragments is directly pipetted and can be directly used for liquid chromatography-tandem mass spectrometry detection.

In some embodiments, the magnetic rod plate adopts standard 96-well plate dimensions, with a thickness of about 2 mm, matched with liquid chromatography autosamplers from various brands. Therefore, the completely assembled magnetic rod plate with the magnetic rod can be embedded into an autosampler, an injection plate is then placed on the magnetic rod plate, residual magnetic beads and magnetic fragments in the sample in reagent tubes are adsorbed and gathered and no longer move, and in a case of not pipetting a supernatant, the supernatant without magnetic fragments can be pipetted by an injection needle, and injection is completed.

In some embodiments, the dimensions of the magnetic rod plate can also be designed and matched according to practical requirements.

Although the method for further treatment still adopts magnetic materials such as a magnetic rod, this may raise a question: why is it that the final step of the magnetic bead extraction process is also magnetic rod treatment that cannot completely remove magnetic beads, resulting in residual magnetic beads or magnetic fragments present in the sample, which cannot be directly used for detection, but the sample treated again with a magnetic rod can be directly used for detection. After analysis, two main reasons why the magnetic rod treatment in the final step of the magnetic bead extraction process cannot completely remove magnetic beads or magnetic fragments are as follows: 1. in the final step of the magnetic bead extraction process, an eluent for the sample contains abundant magnetic beads, and due to the too high content of magnetic beads, using magnetic rod treatment may adsorb and remove about 99% of the magnetic beads, but it is difficult to adsorb and remove 100% of the magnetic beads; 2. in the final step of the magnetic bead extraction process, magnetic rod treatment is carried out in a manner that the magnetic beads are adsorbed and removed from the eluent, the magnetic rod needs to be withdrawn from the sample during removal, and the withdrawal process easily results in that part of adsorbed magnetic beads fall again into the sample.

The reason why the sample treated again with a magnetic rod can be directly used for detection may be that: when the sample is treated again, the magnetic rod can be fixed near the sample such that the magnetic beads therein are completely adsorbed and immobilized by the magnetic rod, if no external force affects, all the magnetic beads will definitely be completely adsorbed on the wall closest to the magnetic rod, and the magnetic beads or magnetic fragments are definitely not present in the remaining sample; at this point, chromatographic detection can be carried out only by pipetting the remaining sample, without a phenomenon of device pipeline blockage or gathering at a six-way valve rotor.

Further, the magnetic material needs to be close to the sample, and the be close to the sample includes placing the sample within a range of a magnetic field emitted by the magnetic material.

Further, after being close to the sample, the magnetic material needs to be kept at a fixed position relative to the sample, such that the residual magnetic beads in the sample are adsorbed and gathered and no longer move.

Further, the magnetic material may be close to the sample one or more times, but after being close to the sample for the last time, the magnetic material needs to be kept at a fixed position relative to the sample.

Further, the placing the sample within a range of a magnetic field emitted by the magnetic material includes making the magnetic material in direct or indirect contact with the sample, or forming a gap between the magnetic material and the sample, or placing the magnetic material within the sample.

Further, the sample is placed in a reagent tube, and a magnetic rod is located outside the reagent tube and is close to an outer wall of the reagent tube, such that the sample in the reagent tube is entirely within the range of the magnetic field emitted by the magnetic material.

Further, the magnetic material includes the magnetic rod.

Further, a height of the magnetic rod is not lower than that of the sample in the reagent tube.

In some embodiments, the height of the magnetic rod is more than 1 times the height of the sample in the reagent tube, such that the residual magnetic beads in the sample can be more effectively immobilized.

In some embodiments, the height of the magnetic rod can be selected according to the height of the reagent tube or the height of the sample in the reagent tube.

Further, the sample is placed in a well plate provided with multiple reagent tubes, the magnetic rod is vertically fixed onto a magnetic rod plate, and the well plate is combined with the magnetic rod on the magnetic rod plate, such that the magnetic rod is placed close to reagent tube walls.

Further, the magnetic rod is placed by extending into a gap between the reagent tubes so as to be placed close to the reagent tube walls.

Further, the magnetic rod extends upward from a gap below the reagent tubes, or the well plate sleeves the magnetic rod from above.

Further, a periphery of each magnetic rod is close to tube walls of more than one reagent tube, such that the residual magnetic beads in the sample in the reagent tubes are capable of being simultaneously adsorbed and gathered and no longer move.

Further, the well plate includes any one or more of a 32-well plate, a 96-well plate, and a 384-well plate.

Further, a periphery of each magnetic rod is close to tube walls of four reagent tubes, such that the residual magnetic beads in the sample in the four reagent tubes are capable of being simultaneously adsorbed and gathered and no longer move.

In some embodiments, the magnetic rod is cylindrical or is in a triangular prism shape, a quadrangular prism shape, or a pentagonal prism shape.

In some embodiments, the magnetic rod is in a regular quadrangular prism shape with a square bottom surface. It has been proven by research that when the magnetic rod is in a regular quadrangular prism shape, residual magnetic beads or magnetic fragments in the sample can be removed more effectively, and the reason may be that four side surfaces of the regular quadrangular prism-shaped magnetic rod can more closely fit the reagent tube on the well plate, such that the magnetic adsorption effect can be exerted more effectively.

Further, the detection is high performance liquid chromatography detection or high-performance liquid chromatography-tandem mass spectrometry detection.

In another aspect, the present application provides a magnetic rod plate, including a base plate and a magnetic rod, wherein when the base plate is placed horizontally, the magnetic rod is vertically placed on the base plate.

Further, the base plate is provided with grooves into which one end of the magnetic rod is inserted, such that the magnetic rod is vertically fixed onto the base plate.

Further, the number of the magnetic rod is one or more, and when multiple magnetic rods are present, a spacing between the vertically placed magnetic rods is capable of accommodating at least one vertically placed reagent tube.

Further, the magnetic rod plate can be used in match with the 32-well plate, the 96-well plate, or the 384-well plate, and according to the specifications of the 32-well plate, the 96-well plate, and the 384-well plate, magnetic rod plates with corresponding dimensions can be made respectively for matched use.

In yet another aspect, the present application provides a sample treatment system, including the magnetic rod plate described above and a well plate provided with multiple reagent tubes, wherein the well plate is capable of being combined with the magnetic rod on the magnetic rod plate, and the magnetic rod is placed close to reagent tube walls so as to treat a sample in the reagent tubes, such that the sample is capable of being directly used for detection.

Further, the well plate is combined with the magnetic rod on the magnetic rod plate in a manner that the magnetic rod extends into a gap between the reagent tubes so as to be placed close to the reagent tube walls.

Further, a height of the magnetic rod is matched with a height of the reagent tubes in the well plate, such that 100% of magnetic beads or magnetic fragments are immobilized on inner walls of the reagent tubes as far as possible.

In yet another aspect, the present application provides a further purification treatment method for a sample after magnetic bead extraction, wherein the method uses the sample treatment system described above for treatment, and the sample after treatment can be directly used for liquid chromatography injection detection.

The present application has the following beneficial effects:

(1) The operation is simple and efficient, the sample after treatment can be directly used for chromatographic detection, and the accuracy of detection results can be ensured to the maximum extent.

(2) The magnetic rod plate for matched use is simple in structure and low in cost, and can be reused infinitely.

(3) The present application greatly facilitates subsequent further purification treatment of the sample after magnetic bead extraction, and has broad market prospects.

### BRIEF DESCRIPTION OF THE DRAWINGS

FIG. 1 shows a structural view of a magnetic rod plate provided in Example 1;

FIG. 2 shows a structural view of a sample treatment system provided in Example 1;

FIG. 3 shows a structural view of combination of a magnetic rod plate and a 96-well plate provided in Example 1;

FIG. 4 shows a longitudinal cross-sectional view of combination of a magnetic rod plate and a 96-well plate provided in Example 1;

FIG. 5 shows a transverse cross-sectional view of combination of a magnetic rod plate and a 96-well plate provided in Example 1;

FIG. 6 shows a structural view of a regular quadrangular prism-shaped magnetic rod plate and a 96-well plate provided in Example 1;

FIG. 7 shows a transverse cross-sectional view of combination of a regular quadrangular prism-shaped magnetic rod plate and a 96-well plate provided in Example 1;

FIG. 8 shows a structural design drawing of a base plate of a magnetic rod plate provided in Example 1;

FIG. 9 shows real pictures of a magnetic rod plate and a 96-well plate provided in Example 1;

FIG. 10 shows real pictures where magnetic beads are adsorbed by magnetic rods provided in Example 1;

FIG. 11 shows a treatment flowchart of a sample after magnetic bead extraction provided in Example 2;

FIG. 12 shows a detection graph for more than 1,900 times of liquid chromatography-tandem mass spectrometry detection for 25-hydroxyvitamin D2 and 25-hydroxyvitamin D3 in Example 2;

FIG. 13 shows schematic drawings of effects of immobilization and adsorption treatment of a sample after magnetic bead extraction with different lengths of magnetic rods provided in Example 4, where the left drawing shows a schematic drawing of a treatment effect when a magnetic rod has a height similar to that of a reagent tube and is significantly higher than the sample in the reagent tube, and the right drawing shows a schematic drawing of a treatment effect when a magnetic rod has a height similar to that of the sample in the reagent tube and is not higher than the sample in the reagent tube.

### DETAILED DESCRIPTION OF THE INVENTION

The present application will be further described in detail below in conjunction with the drawings and examples. It needs to be noted that the examples described below are intended to facilitate the understanding of the present application without any limiting effect.

### Example 1. Magnetic Rod Plate and Sample Treatment System Provided by the Present Application

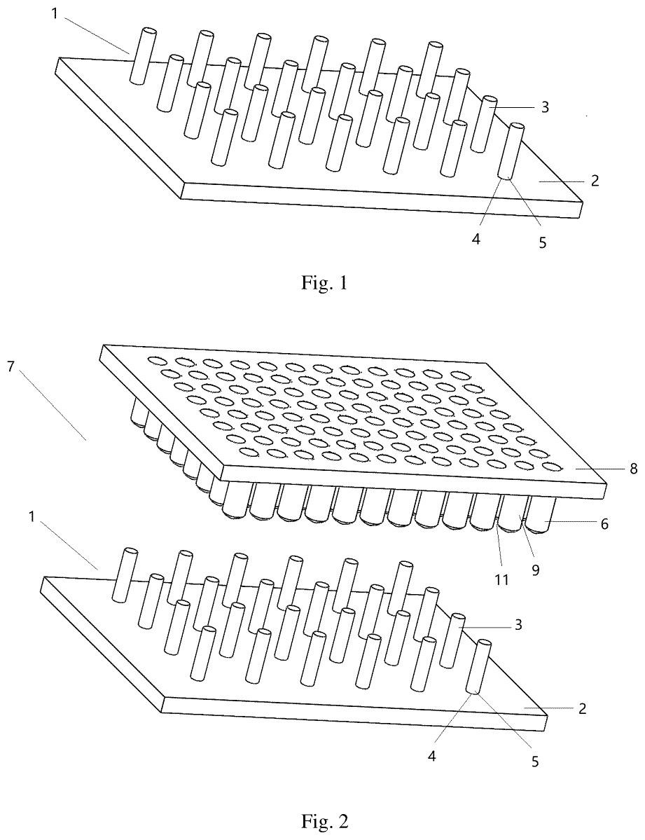

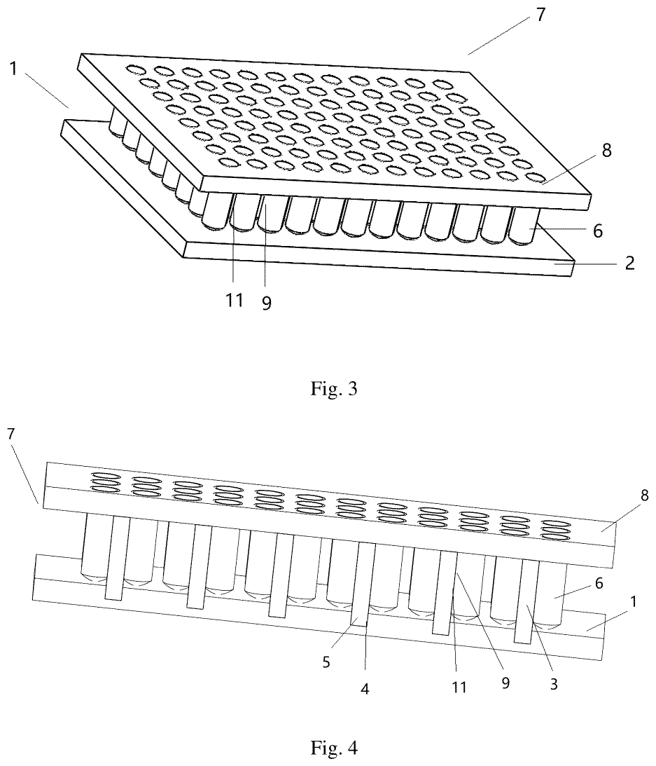

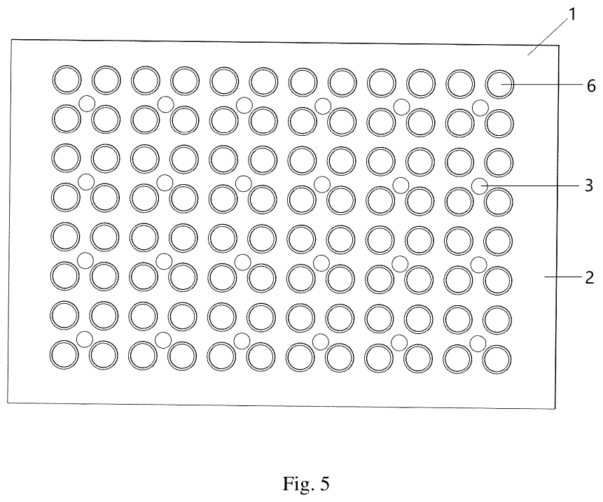

The structure of a magnetic rod plate provided in this example is shown in FIG. 1, the structure of a sample treatment system is shown in FIG. 2, the structural view of combination of the magnetic rod plate and a 96-well plate is shown in FIG. 3, the longitudinal cross-sectional view of combination of the magnetic rod plate and the 96-well plate is shown in FIG. 4, and the transverse cross-sectional view of combination of the magnetic rod plate and the 96-well plate is shown in FIG. 5.

As shown in FIG. 1, a magnetic rod plate 1 includes a base plate 2 and a magnetic rod 3. When the base plate 2 is placed horizontally, the magnetic rod 3 is vertically placed on the base plate 2. Preferably, the base plate 2 is provided with a groove 4 into which one end 5 of the magnetic rod 3 is inserted, such that the magnetic rod 3 is vertically and detachably fixed onto the base plate 2.

The number of the magnetic rod 3 can be designed as required and may be one or more. The magnetic rods 3 may be uniformly distributed on the base plate 2 or arbitrarily distributed as required. In this example, the magnetic rods 3 are uniformly distributed and vertically fixed onto the base plate 2, and a spacing between the vertically placed magnetic rods 3 can accommodate at least one vertically placed reagent tube 6, such that the magnetic rods 3 can be inserted into gaps 11 between the reagent tubes 6.

As shown in FIG. 2, a sample treatment system 7 provided in this example includes a magnetic rod plate 1 and a well plate 8 (being a 96-well plate in this example) provided with multiple reagent tubes 6. The well plate 8 can be combined with the magnetic rod 3 on the magnetic rod plate 1 (FIG. 3), and the magnetic rod 3 is placed close to reagent tube walls 9 so as to treat a sample in the reagent tubes 6, such that the sample can be directly used for detection. The height of the magnetic rod 3 is the same as or is slightly lower than that of the reagent tubes 6. When the reagent tubes 6 are loaded with the sample, since the height of the sample is generally significantly lower than that of the reagent tubes 6, the height of the magnetic rod 3 can be significantly higher than that of the sample in the reagent tubes 6.

As shown in FIG. 4, the well plate 8 is combined with the magnetic rod on the magnetic rod plate 1 in a manner that the magnetic rod 3 extends into a gap 11 between the reagent tubes 6 so as to be placed close to the reagent tube walls 9. As shown in FIG. 5, in this example, for the 96-well plate, each magnetic rod 3 is exactly located at the center of four reagent tubes 6 in the 96-well plate, thereby enabling to adsorb and immobilize residual magnetic beads or magnetic fragments in sample in the four reagent tubes 6 around the magnetic rod 3.

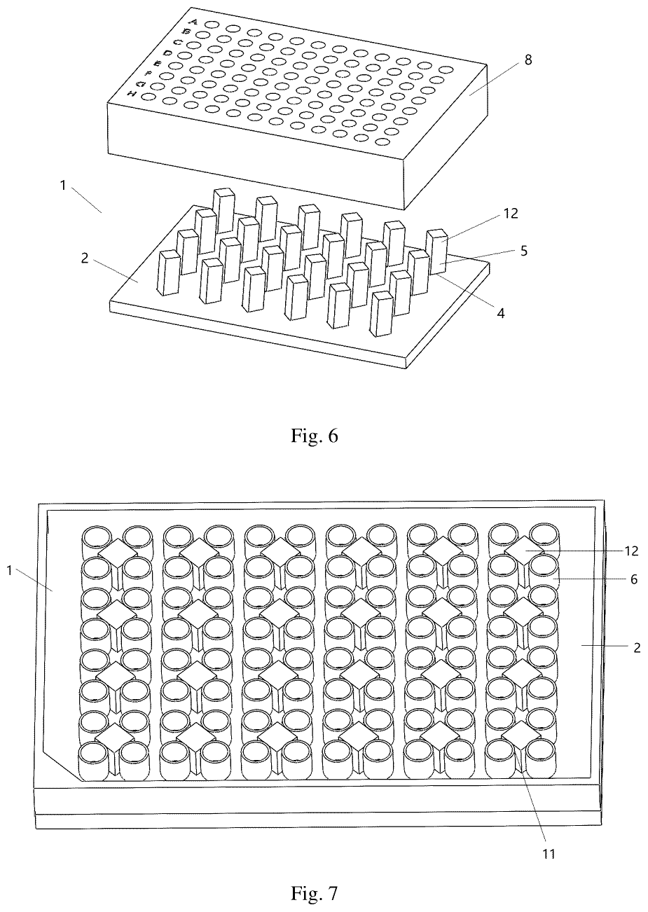

As shown in FIGS. 1-4, the magnetic rods 3 are all cylindrical. In practice, the magnetic rods 3 may be in various shapes, such as a triangular prism shape, a quadrangular prism shape, and a pentagonal prism shape, or may be in a prism shape with an irregular bottom. In this example, a preferred magnetic rod 3 is a regular quadrangular prism-shaped magnetic rod 12. As shown in FIGS. 6 and 7, a magnetic rod 3 is a regular quadrangular prism-shaped magnetic rod 12.

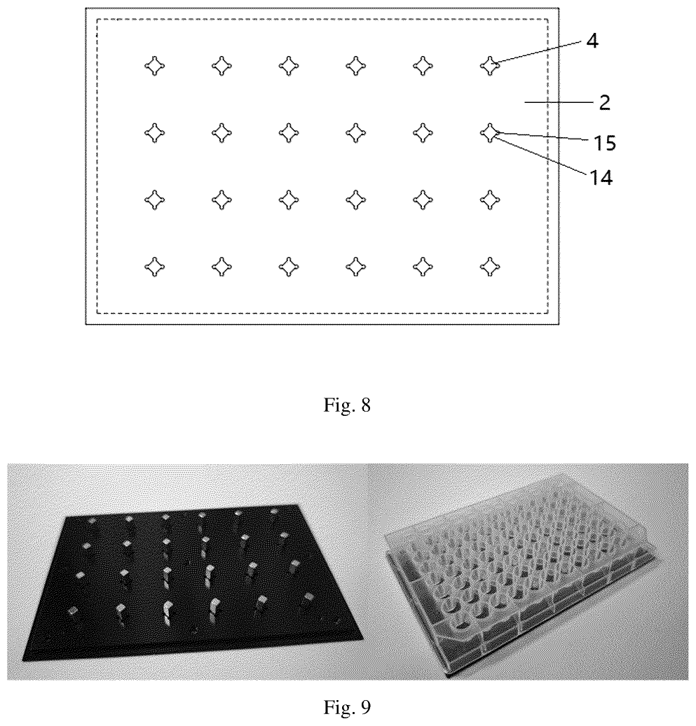

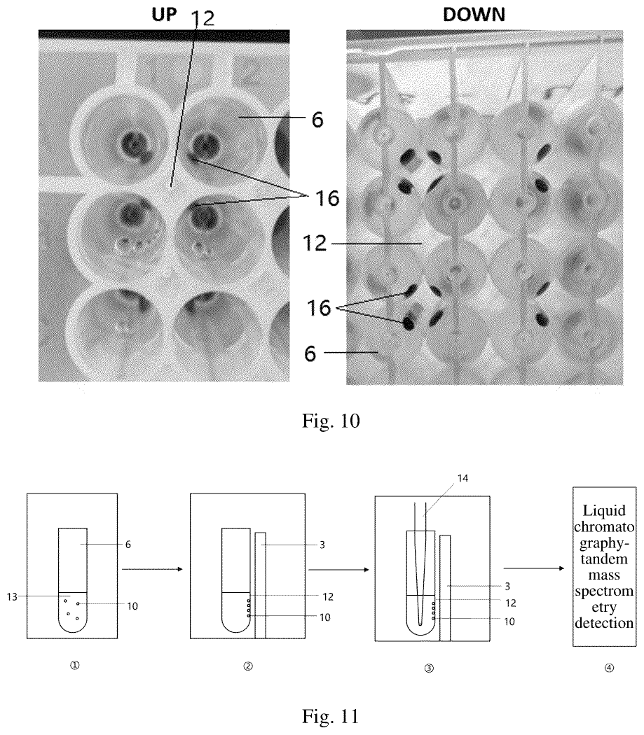

FIG. 8 shows a design view of a base plate 2 of a magnetic rod plate 1, where magnetic rods 3 are not inserted, so multiple grooves 4 can be seen on the base plate 2. A bottom surface 13 of the groove 4 approximates a square shape rather than a circular shape, and is suitable for the insertion of a regular quadrangular prism-shaped magnetic rod 12 with a bottom surface that is also square. Four circular protrusions 15 are further arranged at four corners of a square 14 of the bottom surface 13 of the groove 4, respectively. Such a configuration, on the one hand, can facilitate the insertion of the regular quadrangular prism-shaped magnetic rod 12; meanwhile, if the regular quadrangular prism-shaped magnetic rod 12 is squeezed, the circular protrusions 15 can play a role in certain buffering on the positions of the four corners, thereby prolonging the service life. As a gap 11 formed after four reagent tubes 6 are combined approximates a square rather than a circular shape, the regular quadrangular prism-shaped magnetic rod 12 more fits the gap 11 and is closer to a reagent tube wall 9, thereby exerting a better magnetic absorption treatment effect. The real pictures of a magnetic rod plate and a 96-well plate are shown in FIGS. 9 and 10. The left image of FIG. 10 is viewed from above the reagent tube, and the right image is viewed from below the reagent tube. It can be seen that the residual magnetic beads 16 in the reagent tube 6 are adsorbed and fixed by the regular quadrangular prism-shaped magnetic rod 12.

### Example 2. Treatment Method for Sample after Magnetic Bead Extraction

First, a sample was subjected to magnetic bead extraction using a 96-well plate matched with a magnetic bead extraction instrument. Reagents added to each column of the 96-well plate are as shown in Table 1.

TABLE 1
Reagents Added to Each Column of 96-Well Plate Matched
with Magnetic Bead Extraction Instrument

| Column 1(7) | Column 2(8) | Column 3(9) | Column 4(10) | Column 5(11) | Column 6(12) |
|---|---|---|---|---|---|
| Magnetic bead | Activating | Sample | Leaching | Leaching | Eluent |
| solution | agent | | solution 1 | solution 2 | |
| Magnetic bead | Activating | Sample | Leaching | Leaching | Eluent |
| solution | agent | | solution 1 | solution 2 | |
| Magnetic bead | Activating | Sample | Leaching | Leaching | Eluent |
| solution | agent | | solution 1 | solution 2 | |
| Magnetic bead | Activating | Sample | Leaching | Leaching | Eluent |
| solution | agent | | solution 1 | solution 2 | |
| Magnetic bead | Activating | Sample | Leaching | Leaching | Eluent |
| solution | agent | | solution 1 | solution 2 | |
| Magnetic bead | Activating | Sample | Leaching | Leaching | Eluent |
| solution | agent | | solution 1 | solution 2 | |
| Magnetic bead | Activating | Sample | Leaching | Leaching | Eluent |
| solution | agent | | solution 1 | solution 2 | |
| Magnetic bead | Activating | Sample | Leaching | Leaching | Eluent |
| solution | agent | | solution 1 | solution 2 | |

Magnetic bead extraction included the following steps: 1. a magnetic rod was used to adsorb magnetic beads from Column 1(7), and the magnetic beads were added to an activating agent in Column 2(8); 2. the magnetic rod was used to adsorb the activated magnetic beads, and the activated magnetic beads were added to a sample in Column 3(9), such that the magnetic beads bound to target molecules in the sample; 3. the magnetic beads were taken out from Column 3(9) and added to Column 4(10) for first washing; 4. the magnetic beads were taken out from Column 4(10) and added to Column 5(11) for second washing; 5. the magnetic beads were taken out from Column 5(11) and added to Column 6(12) for magnetic bead elution, such that the target molecules were separated from the magnetic beads; and 6. the magnetic rod was used to adsorb and remove the magnetic beads from Column 6(12), and the remaining solution in Column 6(12) is a sample after magnetic bead extraction.

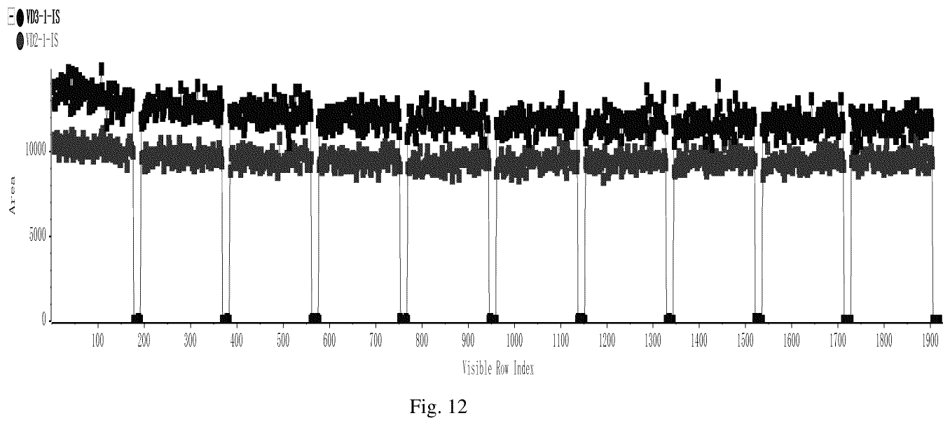

The sample after magnetic bead extraction was subjected to further purification treatment using the magnetic rod plate provided in Example 1: a 96-well plate (8) loaded with the sample after magnetic bead extraction sleeved a magnetic rod 3 of a magnetic rod plate (1) from above, such that the magnetic rod 3 extended into a gap (11) between reagent tubes (6) (see FIG. 7 or Real Picture 10), and each magnetic rod 3 was exactly located at the center of four reagent tubes 6 in the 96-well plate, thereby enabling to adsorb and immobilize residual magnetic beads 10 in sample in the four reagent tubes 6 around the magnetic rod 3. The schematic view for the process for adsorbing the magnetic beads 10 is shown in FIG. 11: \textcircled{1} Residual magnetic beads 10 were present in the sample after magnetic bead extraction 13; \textcircled{2} when the magnetic rod 3 was close to a reagent tube wall 9, the magnetic beads 10 were all adsorbed onto an inner wall 12 of a reagent tube under the action of the magnetic rod 3; \textcircled{3} at this point, a pipette tip 14 was used to pipette the sample without the immobilized magnetic beads 10 from the reagent tube 6; \textcircled{4} liquid chromatography-tandem mass spectrometry detection was carried out directly.

For example, the sample treated using the treatment method was subjected to over 1,000 times of liquid chromatography-tandem mass spectrometry detection for 25-hydroxyvitamin D2 and 25-hydroxyvitamin D3, in which all operations were normal, no pipeline blockage by the magnetic beads was found, and the internal standard coefficient of variation (CV) remained stable. The detection results are shown in Table 1.

TABLE 1
Internal Standard Response CV and Full Width
at Half Maxima CV for Consecutive Injection
of 1,000 Samples after Magnetic Bead Extraction

| Item to | Internal standard response | | Full width at half maxima | |
|---|---|---|---|---|
| be detected | VD3-IS | VD2-IS | VD3-IS | VD2-IS |
| AVERAGE | 12057.3 | 9547.4 | 1.52E−02 | 1.60E−02 |
| SD | 748.1 | 452.1 | 1.05E−03 | 9.21E−04 |
| CV | 6.20% | 4.70% | 6.90% | 5.80% |

The graph for internal standard response detection for consecutive injection of 1,000 samples after magnetic bead extraction is shown in FIG. 12, where a blue analyte represents 25OH-VD2-d3, a rosy analyte represents 25OH-VD3-d6, and a point with an internal standard response being zero represents a blank.

### Example 3. Comparison Between Different Treatment Methods for Sample after Magnetic Bead Extraction

In this example, 100 μL of a blood sample was treated before magnetic bead extraction according to the method in Example 2, in which an activating agent was 200 μL of a 50% methanol aqueous solution; leaching solution 1 was 400 μL of a 10% methanol aqueous solution; leaching solution 2 was 400 μL of water; and an eluent was 200 μL of a 50% methanol aqueous solution. The sample after magnetic bead extraction was subjected to further purification treatment respectively using the following three methods: 1. magnetic rod immobilization and adsorption (Example 2); 2. filtration with a 0.45 μm PTFE filter plate; 3. centrifugation in a 96-well plate at 4,000 rpm for 10 minutes, and supernatant transfer for injection. After further purification treatment using the three methods, liquid chromatography-tandem mass spectrometry detection was carried out respectively, in which Disigns-Column 003 chromatographic column was used, mobile phase A was water with 0.1% formic acid, mobile phase B was methanol with 0.1% formic acid, 1,000 injections was carried out respectively for detection of 25-hydroxyvitamin D3, the full width at half maxima was detected, the average values, the standard deviation (SD) values, and the CV values were counted, and the column pressure changes and the pipeline blockage situations were recorded. The results are shown in Table 2.

TABLE 2
Influences of Different Purification Treatment Methods on Detection Results

| | Full width at | | | Column | Pipeline |
|---|---|---|---|---|---|
| Purification | half maxima (min) | | | pressure | blockage |
| treatment method | AVERAGE | SD | CV (%) | (MPa) | situation |
| Magnetic rod | 1.505E−02 | 7.675E−04 | 5.1 | No change | No blockage |
| immobilization | | | | | |
| and adsorption | | | | | |
| Filtration with | 1.515E−02 | 1.053E−03 | 6.9 | Increased by | No blockage |
| a filter plate | | | | 3 MPa | |
| Centrifugation | 1.598E−02 | 1.601E−03 | 10.1 | Increased by | One blockage |
| | | | | 6 MPa | |

The detection results showed that after treatment using the first method, 1,000 injections were carried out, with no significant change in column pressure, no pipeline blockage, and a lower CV value, so the detection results were more stable and accurate; after treatment using the second method, 1,000 injections were carried out, with a column pressure increased by about 3 MPa and no pipeline blockage; after treatment using the third method, 1,000 injections were carried out, with a column pressure increased by about 6 MPa and one pipeline blockage, which was speculated that the reason might be that small magnetic fragments floated or were suspended in the injection solution and were difficult to be precipitated to the bottom of the reagent tube by centrifugation, or the precipitate at the bottom of the reagent tube was disturbed during pipetting after centrifugation.

By means of treatment using the method provided by the present application, the durability of the detection system can be significantly improved, and the reason may be that the sample in the second method needs to be subjected to filtration with a filter plate, which may involve non-specific adsorption and cannot remove small magnetic particles with a diameter of <0.45 μm; and the third purification method cannot effectively remove low-density small magnetic particles. Residual small magnetic particles in the injected solution can cause pipeline blockage, which affects the service life and stability of the detection system. However, the method provided by the present application can better remove all magnetic particles in the sample, ensuring more thorough purification of the sample before entering the detection system.

### Example 4. Influences of Magnetic Rod Lengths and Shapes on Sample Treatment Effect

### 1. Influences of Magnetic Rod Lengths on Sample Treatment Effect

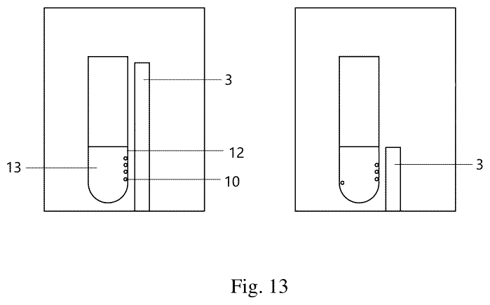

In this example, the first method provided in Example 3 was used to conduct magnetic rod immobilization and adsorption treatment on the sample after magnetic bead extraction, in which the magnetic rod was in a regular quadrangular prism shape and had lengths as follows: (1) the magnetic rod had a height similar to that of the reagent tube and was significantly higher than the sample in the reagent tube (the left drawing in FIG. 13); (2) the magnetic rod had a height similar to that of the sample in the reagent tube and was not higher than the sample in the reagent tube (the right drawing in FIG. 13). The samples respectively treated with two different lengths of magnetic rods were subjected to 2,000 times of liquid chromatography-tandem mass spectrometry detection, in which in group (1), when the magnetic rod had a height similar to that of the reagent tube, all operations were normal, and no pipeline blockage by the magnetic beads was found; in group (2), one pipeline blockage by the magnetic beads appeared.

It was analyzed that the reason might be that when the magnetic rod had a higher height, the magnetic rod had a stronger magnetic field that enabled all the sample to be within the range of the stronger magnetic field, ensuring that one hundred percent magnetic beads were immobilized; however, when the height of the magnetic rod was decreased to be less than or equal to the height of the sample, part of the sample might be within the range of a weaker magnetic field, which affected the effects of adsorption and immobilization of the magnetic beads, and occasionally might result in that some magnetic beads escaped the adsorption effect of the magnetic field, reducing the treatment effect.

In this example, it has been proven by research that when the height of the magnetic rod is more than 1.2 times the height of the sample, thousands of normal operations can be achieved better without pipeline blockage by magnetic beads.

### 2. Influences of Magnetic Rod Shapes on Sample Treatment Effect

In this example, the first method provided in Example 3 was used to conduct magnetic rod immobilization and adsorption treatment on the sample after magnetic bead extraction, in which the magnetic rod had shapes as follows: (1) a cylindrical shape (FIGS. 1-5); (2) a regular quadrangular prism shape (FIGS. 6-7). The samples respectively treated with two different shapes of magnetic rods were subjected to 5,000 times of liquid chromatography-tandem mass spectrometry detection, in which in group (2), for the regular quadrangular prism-shaped magnetic rod, all operations were normal, and no pipeline blockage by the magnetic beads was found; in group (1), for the cylindrical magnetic rod, one pipeline blockage by the magnetic beads appeared.

It was analyzed that the reason might be that the regular quadrangular prism-shaped magnetic rod more fitted a gap 11 formed after four reagent tubes 6 are combined, and thus could exert a better magnetic adsorption effect, thereby achieving a more stable magnetic adsorption purification effect. Therefore, the regular quadrangular prism-shaped magnetic rod was preferred for further purification treatment.

In other embodiments, below are also the invention of this application:
1. A treatment method for a sample, comprising the steps:
   step 1: providing a sample that is treated by a first magnetic bead extraction,
   step 2: after step 1, using a magnetic material to immobilize the residual magnetic beads in the sample;
   step 3: collecting the sample without fixed the residual magnetic beads for detecting directly.
2. The method according to the clause 1, before step 1, the sample that is contracted with magnetic beads and the target molecules were bound by the beads, and then, using an elution for separating the target molecules from the magnetic beads to forming a elution solution; using a magnetic rod that is inserted into the elution solution to remove the magnetic beads from the elution solution.
3. The method according to the clause 1, before step 1, Magnetic bead extraction further included the following steps: 1. a magnetic rod was used to adsorb magnetic beads from Column 1(7), and the magnetic beads were added to an activating agent in Column 2(8); 2. the magnetic rod was used to adsorb the activated magnetic beads, and the activated magnetic beads were added to a sample in Column 3(9), such that the magnetic beads bound to target molecules in the sample; 3. the magnetic beads were taken out from Column 3(9) and added to Column 4(10) for first washing; 4. the magnetic beads were taken out from Column 4(10) and added to Column 5(11) for second washing; 5. the magnetic beads were taken out from Column 5(11) and added to Column 6(12) for magnetic bead elution, such that the target molecules were separated from the magnetic beads; and 6. the magnetic rod was used to adsorb and remove the magnetic beads from Column 6(12), and the remaining solution in Column 6(12) is a sample after magnetic bead extraction.
4. The treatment method according to clause 2, wherein in the step 2, letting the magnetic material be close to the elution solution comprise placing the elution solution within a range of a magnetic field emitted by the magnetic material.
5. The treatment method according to clause 4, wherein after being close to the elution solution, the magnetic material needs to be kept at a fixed position relative to the elution solution, such that the residual magnetic beads in the elution solution are adsorbed and gathered and no longer move.
6. The treatment method according to clause 2, wherein the magnetic material may be close to the elution solution one or more times, but after being close to the elution solution for the last time, the magnetic material needs to be kept at a fixed position relative to the elution solution
7. The treatment method according to clause 2, wherein the placing the sample within a range of a magnetic field emitted by the magnetic material comprises making the magnetic material in direct or indirect contact with the elution solution, or forming a gap between the magnetic material and the elution solution e, or placing the magnetic material within the elution solution.
8. The treatment method according to clause 5, wherein the elution solution is placed in a reagent tube and the magnetic material is a magnetic rod the magnetic rod is located outside the reagent tube and is close to an outer wall of the reagent tube, such that the elution solution in the reagent tube is entirely within the range of the magnetic field emitted by the magnetic material.
9. The treatment method according to clause 6, wherein a height of the magnetic rod is not lower than that of the elution solution in the reagent tube.
10. The treatment method according to clause 7, wherein the elution solution is placed in a well plate provided with multiple reagent tubes, the magnetic rod is vertically fixed onto a base plate, and the well plate is combined with the magnetic rod on the base plate, such that the magnetic rod is placed close to reagent tube walls.
11. The treatment method according to clause 8, wherein the magnetic rod is placed by extending into a gap between the reagent tubes so as to be placed close to the reagent tube walls.
12. The treatment method according to clause 9, wherein the magnetic rod extends upward from a gap below the reagent tubes, or the well plate sleeves the magnetic rod from above.
13. The treatment method according to clause 9, wherein a periphery of each magnetic rod is close to tube walls of more than one reagent tube, such that the residual magnetic beads in the elution solution in the reagent tubes are capable of being simultaneously adsorbed and gathered and no longer move.
14. The treatment method according to clause 9, wherein the well plate comprises any one or more of a 32-well plate, a 96-well plate, and a 384-well plate.
15. The treatment method according to clause 12, wherein a periphery of each magnetic rod is close to tube walls of four reagent tubes, such that the residual magnetic beads in the elution solution in the four reagent tubes are capable of being simultaneously adsorbed and gathered and no longer move.
16. The treatment method according to clause 1, wherein in step 3, the detection is liquid chromatography-tandem mass spectrometry detection.
17. The treatment method according to clause 8, wherein the magnetic rod and the base plate form a magnetic rod plate, when the base plate is placed horizontally, the magnetic rod is vertically placed on the base plate.
18. The treatment method according to clause 15, wherein the base plate is provided with grooves into which one end of the magnetic rod is inserted, such that the magnetic rod is vertically fixed onto the base plate.
19. The treatment method according to clause 16, wherein the number of the magnetic rod is one or more, and when multiple magnetic rods are present, a spacing between the vertically placed magnetic rods is capable of accommodating at least one vertically placed reagent tube.
20. The treatment method according to clause 17, wherein combine the well plate with the magnetic rod plate, so that the magnetic rod in the magnetic rod plate is close to the wall of the reagent tube in the well plate, so that the sample in the reagent tube can be directly used for detection.
21. The treatment method according to clause 18, wherein the well plate is combined with the magnetic rod on the magnetic rod plate in a manner that the magnetic rod extends into a gap between the reagent tubes so as to be placed close to the reagent tube walls.
22. The treatment method according to clause 19, wherein a height of the magnetic rod is matched with that of the reagent tubes in the well plate.

Although the present application has been disclosed above, it is not limited thereto. Any person skilled in the art can make various changes and modifications without departing from the spirit and scope of the present application. Consequently, the scope of protection of the present application shall be defined by the scope of the claims.

1. A treatment method for a sample, comprising the steps of:
Step 1: providing a sample that is treated by a first magnetic bead extraction,
step 2: using a magnetic material to immobilize residual magnetic beads in the sample;
step 3: collecting the sample without fixed the residual magnetic beads for detecting directly.

2. The treatment method for a sample according to claim 1, wherein in the step 2, letting the magnetic material be close to the sample comprise placing the sample within a range of a magnetic field emitted by the magnetic material.

3. The treatment method for a sample according to claim 2, wherein after being close to the sample, the magnetic material needs to be kept at a fixed position relative to the sample, such that the residual magnetic beads in the sample are adsorbed and gathered and no longer move.

4. The treatment method for a sample according to claim 2, wherein the magnetic material may be close to the sample one or more times, but after being close to the sample for the last time, the magnetic material needs to be kept at a fixed position relative to the sample.

5. The treatment method for a sample according to claim 2, wherein the placing the sample within a range of a magnetic field emitted by the magnetic material comprises making the magnetic material in direct or indirect contact with the sample, or forming a gap between the magnetic material and the sample, or placing the magnetic material within the sample.

6. The treatment method for a sample according to claim 5, wherein the sample is placed in a reagent tube and the magnetic material is a magnetic rod, the magnetic rod is located outside the reagent tube and is close to an outer wall of the reagent tube, such that the sample in the reagent tube is entirely within the range of the magnetic field emitted by the magnetic material.

7. The treatment method for a sample according to claim 6, wherein a height of the magnetic rod is not lower than that of the sample in the reagent tube.

8. The treatment method for a sample according to claim 7, wherein the sample is placed in a well plate provided with multiple reagent tubes, the magnetic rod is vertically fixed onto a base plate, and the well plate is combined with the magnetic rod on the base plate, such that the magnetic rod is placed close to reagent tube walls.

9. The treatment method for a sample according to claim 8, wherein the magnetic rod is placed by extending into a gap between the reagent tubes so as to be placed close to the reagent tube walls.

10. The treatment method for a sample according to claim 9, wherein the magnetic rod extends upward from a gap below the reagent tubes, or the well plate sleeves the magnetic rod from above.

11. The treatment method for a sample according to claim 9, wherein a periphery of each magnetic rod is close to tube walls of more than one reagent tube, such that the residual magnetic beads in the sample in the reagent tubes are capable of being simultaneously adsorbed and gathered and no longer move.

12. The treatment method for a sample according to claim 9, wherein the well plate comprises any one or more of a 32-well plate, a 96-well plate, and a 384-well plate.

13. The treatment method for a sample according to claim 12, wherein a periphery of each magnetic rod is close to tube walls of four reagent tubes, such that the residual magnetic beads in the sample in the four reagent tubes are capable of being simultaneously adsorbed and gathered and no longer move.

14. The treatment method for a sample according to claim 1, wherein in step 3, the detection is liquid chromatography-tandem mass spectrometry detection.

15. The treatment method for a sample according to claim 8, wherein the magnetic rod and the base plate form a magnetic rod plate, when the base plate is placed horizontally, the magnetic rod is vertically placed on the base plate.

16. The treatment method for a sample according to claim 15, wherein the base plate is provided with grooves into which one end of the magnetic rod is inserted, such that the magnetic rod is vertically fixed onto the base plate.

17. The treatment method for a sample according to claim 16, wherein a number of the magnetic rod is one or more, and when multiple magnetic rods are present, a spacing between the vertically placed magnetic rods is capable of accommodating at least one vertically placed reagent tube.

18. The treatment method for a sample according to claim 17, wherein combine the well plate with the magnetic rod plate, so that the magnetic rod in the magnetic rod plate is close to the wall of the reagent tube in the well plate, so that the sample in the reagent tube can be directly used for detection.

19. The treatment method for a sample according to claim 18, wherein the well plate is combined with the magnetic rod on the magnetic rod plate in a manner that the magnetic rod extends into a gap between the reagent tubes so as to be placed close to the reagent tube walls.

20. The treatment method for a sample according to claim 19, wherein a height of the magnetic rod is matched with that of the reagent tubes in the well plate.
